(19) United States
(12) Patent Application Publication
(10) Pub. No.: US 2025/0166110 A1
(43) Pub. Date: May 22, 2025

(54) CYBER-PHYSICAL WATERMARKING WITH INKJET EDIBLE BIOPRINTING

(71) Applicant: Purdue Research Foundation, West Lafayette, IN (US)

(72) Inventors: Young Kim, West Lafayette, IN (US); Hee Jae Jeon, Gwangju (KR); Jungwoo Leem, West Lafayette, IN (US); Sang Mok Park, West Lafayette, IN (US); Yuhyun Ji, West Lafayette, IN (US)

(73) Assignee: Purdue Research Foundation, West Lafayette, IN (US)

(21) Appl. No.: 18/726,816

(22) PCT Filed: Dec. 23, 2022
(86) PCT No.: PCT/US2022/053918

§ 371 Date: Jul. 4, 2024

Related U.S. Application Data
(60) Provisional application No. 63/301,426, filed on Jan. 20, 2022.

(51) Int. Cl. G06T 1/00; A23P 20/15; A23P 20/25; B41M 3/10; B41M 5/00; H04N 1/32

(52) U.S. Cl. CPC G06T 1/005; A23P 20/15; B41M 3/10; B41M 5/0041; H04N 1/32149; A23P 2020/253

(57) ABSTRACT

A method of ascertaining identity, verification, or authentication of a product is disclosed which includes embedding a predetermined watermark on a host image, thereby generating an edible watermarked image, printing the watermarked image using edible ink on an attack-resistant edible substrate, affixing the printed substrate onto the product, providing a color reference chart along with the watermarked image, obtaining an image of the watermarked image from the product, establishing correspondence between the watermarked image and the color reference chart, correcting the obtained image based on the established correspondence, extracting the embedded predetermined watermark from the corrected watermarked image, and determining identity, verification, and authentication of the product by analyzing the extracted predetermined watermark of the watermarked image.

### CROSS-REFERENCE TO RELATED APPLICATIONS

The present non-provisional patent application is related to and claims the priority benefit of U.S. Provisional Patent Application Ser. No. 63/301,426, entitled CYBER-PHYSICAL WATERMARKING WITH INKJET EDIBLE BIOPRINTING which was filed Jan. 20, 2022, the contents of which are hereby incorporated by reference in its entirety into the present disclosure

### STATEMENT REGARDING GOVERNMENT FUNDING

None.

### TECHNICAL FIELD

The present disclosure generally relates a method of ascertaining identity, verification, and authentication of a product, and in particular to a method of watermarking with digital printing using inkjet or laser printers utilizing edible bioprinting and of extracting an embedded watermark from a watermarked image after error corrections.

### BACKGROUND

This section introduces aspects that may help facilitate a better understanding of the disclosure. Accordingly, these statements are to be read in this light and are not to be understood as admissions about what is or is not prior art.

The prevalence of fake drugs has emerged as a continually growing problem worldwide, regardless of the economic status of countries. In general, fake drugs can be categorized as substandard, falsified, counterfeit, and diverted drugs, and the World Health Organization (WHO) broadly defines a counterfeit medicine as “one which is deliberately and fraudulently mislabeled with respect to identity and/or source.” Pharmaceutical products are the most vulnerable goods that counterfeiters and illicit drug manufacturers deliberately produce for illegal monetary gain worldwide. Notably, counterfeit medicines for malaria and pneumonia are estimated to cause 250,000 child deaths per year. In sub-Saharan Africa, such counterfeit antimalaria drugs are estimated to cost tens of millions of dollars. According to WHO and the United Nations Office on Drugs and Crime, counterfeit drugs account for approximately 10% of the global pharmaceutical trade and 20-30% of all medicines in Africa, Asia, and the Middle East. Furthermore, counterfeit medicines pertaining to both lifestyle and lifesaving drugs appear increasingly common in the U.S. Counterfeit opioids have caused deaths in almost all states of the U.S.

The bolstered distribution of counterfeit medicines and pharmaceutical products can be attributed to the increased use of online pharmacies in recent years and the ongoing COVID-19 pandemic scenario. Approximately 40,000 online pharmacies are currently active worldwide, with an increase of 600 every month. The operation of nearly 96-97% of these online pharmacies is illegal. In the U.S., the opioid epidemic can also be attributed to the illegal online sales of controlled substances without a prescription. The COVID-19 pandemic has promoted the emergence and use of online pharmacies, resulting in the recent surge in counterfeit pharmaceutical products (e.g. fake chloroquine and hydroxychloroquine) and counterfeit medical supplies (e.g. substandard surgical mask and respirator). This trend is expected to continue as the demand exceeds the supply in part because of lockdowns in many drug-producing countries. Several governments have strengthened legislation and enforcement to deter counterfeit medicines. For example, in the U.S., unit-level traceability will be mandated by 2023, following the Drug Supply Chain Security Act set by the United States Food and Drug Administration (FDA). In Europe, the Falsified Medicines Directive requires the implementation of safety features. Although public resources to avoid the unintentional use of illicit online pharmacies are available, patients and healthcare providers (e.g. physician, nurse, and pharmacist) are not well aware of such information.

Traditional methods to identify counterfeit medicines rely on analytical chemistry and spectroscopy. Fluorescence, Raman, infrared, and near-infrared spectrometers represent the first screening tools that can detect counterfeit medicines by analyzing the exact chemical compositions. However, these instrument-dependent methods require specialized devices, complicated readers, and trained personnel. Recently, advanced anticounterfeit technologies, including fluorescent ink printing, microprinting, fingerprint-like encoding strategies, organic electronic devices, nanopillar array paper, 3D microstructure films, and invisible photonic printings, have been developed. However, patients and healthcare professionals have limited access to such analytical chemistry methods and sophisticated anticounterfeit technologies to avoid the unintentional use of counterfeit medicines.

Therefore, there is an unmet need for a novel approach to provide dosage-level (on-dose) anticounterfeit measures and authentication features that can provide protection against counterfeited pharmaceutical and food-related products.

### SUMMARY

A method of ascertaining identity, verification, or authentication of a product is disclosed. The method includes embedding a predetermined watermark on a host image, thereby generating a watermarked image, printing the watermarked image using edible ink on an attack-resistant edible substrate, affixing the printed substrate onto the product, providing a color reference chart along with the watermarked image, obtaining an image of the watermarked image from the product, establishing correspondence between the watermarked image and the color reference chart, correcting the obtained image based on the established correspondence, extracting the embedded predetermined watermark from the corrected watermarked image, and determining identity, verification, and authentication of the product by analyzing the extracted predetermined watermark of the watermarked image.

In the above method, the product is one or more of a pharmaceutical product, a nutritional supplement product, and a food product.

In the above method, the watermarked image is printed using an edible ink.

In the above method, the edible ink is a Food and Drug Administration approved food coloring dye.

In the above method, the watermarked image is printed with an attack-resistant edible substrate material.

In the above method, the attack-resistant edible substrate material includes fluorescent materials.

In the above method, the fluorescent material for the substrate includes material selected from the group consisting of naturally occurring fluorescent proteins, animal-based proteins, plant-based proteins and pigments, lipids, genetically hybridized fluorescent proteins, edible polymers, and fluorescent food coloring dyes.

In the above method, the watermarked image is printed by an inkjet printer or laser printer.

In the above method, the correction of the watermarked image is further based on correcting geometrical distortions which have occurred during the printing and the obtaining steps.

In the above method, the color correction of the watermarked image based on the established correspondence includes establishing a relationship between International Commission on Illumination (CIE) RGB color values of colors in the color reference chart as originally printed and the obtained CIE RGB color values.

In the above method, the established relationship is based on:

$${T}_{3 \times m} = {C}_{3 \times p} {M}_{3 \times m} ,$$

where T and M are 3×m matrices of the original CIE RGB color values of m different reference colors in the color reference chart and the obtained RGB color values of m different reference colors in the color reference chart, and C is a conversion matrix that is used to correct color values of the obtained watermarked image back to the originally printed CIE RGB color values of the watermarked image.

In the above method, the step of extracting the embedded predetermined watermark from the corrected watermarked image is carried out at a first location associated with a priori knowledge of the predetermined watermark.

The above method, further including communicating identity, verification, and authentication of the product from the first location to a second location.

In the above method, the first location is related to where the watermarked image was first printed and the second location is related to wherein the watermarked image was obtained.

In the above method, the first location is related to where the watermarked image was obtained and the second location is related to where the watermarked image was printed.

In the above method, the communicated identity, verification, an authentication include information relevant to the product.

In the above method, the product is one of a pharmaceutical or a food product.

In the above method, the information relevant to the pharmaceutical includes one or more of name of the pharmaceutical, dosage, date of manufacture, date of expiration, location of manufacture, warning of interactions with other drugs, or base ingredients.

In the above method, the information relevant to the pharmaceutical along with information related to where the watermarked image was obtained are communicated to a third location.

In the above method, the third location includes one or more of a physician's office, a medical care facility, a central medical record facility, or the first location.

In the above method, the color reference chart includes metadata associated with the CIE RGB color values of the color reference chart.

In the above method, the metadata is used to establish degradation of the obtained watermarked image since it was first printed on the product.

In the above method, the degradation is result of exposure to one or more of light, moisture, or chemical contaminants.

In the above method, the metadata is used to correct color distortion of the obtained watermarked image since it was first printed on the product.

In the above method, the degradation is result of color distortions during printing and photo acquisition.

In the above method, determining identity of the product includes one or more of i) validation associated with ensuring that the identity represents actual product issued by an actual manufacturer, ii) verification associated with ensuring the identity is corresponding to a particular product; or iii) authentication associated with ensuring the determined product is the product for which the predetermined watermark was embedded in the printed watermarked image.

In the above method, the genetically hybridized fluorescent silk proteins include silk fibroin with one or more of enhanced green fluorescent protein (eGFP), far-red fluorescent protein (mKate2), enhanced cyan fluorescent protein (eCFP), and enhanced yellow fluorescent protein (eYFP).

In the above method, the edible polymers include one or more of hydrocolloids: Starch, cellulose derivatives, chitosan, pectin, alginates, gums, and carrageenans.

In the above method, the animal-based proteins include one or more of silk, gelatin, collagen, albumin, and milk protein.

In the above method, the plant-based proteins include one or more of zein, soy, wheat gluten, and lectins.

In the above method, the lipids include one or more of fatty acids, triglycerides, and phospholipids.

In the above method, the fluorescent food dyes and plant pigments include one or more of Citrus Red (FD&C Red #2), Erythrosine B (FD&C Red #3), Allura Red (FD&C Red #40), Brilliant Blue (FD&C blue #1), Indigo carmine (FD&C blue #2), Fast Green (FD&C Green #3), Orange B, Tartrazine (FD&C Yellow #6), Sunset Yellow (FD&C Yellow #6), Tartrazine (FD&C Yellow #5), Betaxanthins, Chlorophyll, Carotenoids, Anthocyanin, Betalains, Fisetin, Quercetin, Quinine, Curcumin, Anthocyanin, Riboflavin, Vanillin, and Benzaldehyde.

In the above method, the established relationship is further based on incorporating color distortion between the originally printed watermarked image and the obtained CIE RGB color values of the watermarked image.

In the above method, the M_{3×m} matrix is expanded into an M_{p×m} matrix, and thereby the established relationship is based on:

T_{3×m}=C_{3×p} M_{p×m}, wherein the p rows in M_{p×m} include polynomial or root-polynomial expansion terms of CIE RGB values to thereby incorporate a nonlinearity in addition to the CIE RGB color values of the obtained watermark image.

In the above method, an inverse of an expanded conversion matrix C is solved using a least-squares method.

In the above method, the least-squares method includes one of QR decomposition or Moore-Penrose pseudo inverse.

In the above method, the edible ink includes water, glycerin (polyalcohol), ethanol (monoalcohol), FDA-approved color dyes, and a preservative (polysorbate 80, propylene glycol).

In the above method, the FDA-approved color dyes include one or more of FD&C Red #2/Red #3/Red #40, Blue #1/Blue #2, Green #3, Orange B, and Yellow #5/Yellow #6.

In the above method, the preservative includes methylparaben.

### BRIEF DESCRIPTION OF DRAWINGS

FIGS. 1a, 1b, 1c, and 1d are schematics of the basic steps of deploying a cyber-physical watermarking with inkjet edible bioprinting, according to the present disclosure, specifically, the processes involved in a digital watermarked image generation (watermark plus a host image) is shown in FIG. 1a, the printing process is shown in FIG. 1b, how the printed watermarked image combination is cut and used as a taggant for a product by attaching the taggant to the product is shown in FIG. 1c, and how the product with the attached taggant can be on-dose authenticated by using a smartphone is shown in FIG. 1d.

FIG. 1e is a flowchart of a process according to the present disclosure is provided that outlines the steps discussed in FIGS. 1a-1d in a more detailed manner.

FIG. 2a is a schematic of a transformation vector p3×P3-DsRed2-FibH-eGFP for eGFP-expressing silk production by a piggyBac transposon method.

FIGS. 2b and 2c are photographs and fluorescence images of a transgenic eGFP silkworm (FIG. 2b) and silk gland (FIG. 2c).

FIG. 2d provides photographs and fluorescence images of eGFP silk cocoons and regenerated eGFP silk fibroin solutions. The green fluorescence image is obtained using an optical set of excitation (Dex=470 nm) and emission ( ) m=525 nm).

FIG. 2e is a photograph of a large-area eGFP silk fibroin sheet with a diameter of 150 mm and thickness of 75±5 μm.

FIGS. 2f and 2g are photographs and fluorescence images of typical white silk (FIG. 2f) and eGFP silk (FIG. 2g) fibroin print sheets.

FIG. 2h is a graph of reflection (normalized) vs. wavelength in nm showing a comparison of white silk (i.e., non-fluorescent silk) fibroin print sheet and eGFP silk fibroin print sheet which can serve as a tamper-resistant feature for a scan-print attack when a scanner or copier is used to attempt to duplicate a watermarked image.

FIG. 2i provides photographs and fluorescence images of eGFP silk fibroin sheets immersed in physically relevant pepsin (pH 2.2) enzyme or trypsin (pH 7.2) enzyme solutions, obtained at 0 and 90 min, respectively.

FIG. 2j provides photographs and fluorescence images of eGFP silk fibroin print sheets immersed in buffer solutions with the same pH values without proteolytic enzyme.

FIG. 2k is schematics of a fabrication process of the eGFP silk fibroin solution and print sheet substrate, according to one embodiment.

FIG. 2l is graphs of reflection (normalized) vs. wavelength in nm are provided for color and spectral characteristics of FDA-approved food coloring dyes.

FIG. 3a provides microscopic photographs of inkjet droplet wetting of FDA-approved food coloring (green color) on eGFP silk fibroin print sheets.

FIG. 3b provides photographs of a representative of 18 test colors with an opacity of 100% (left) and 40% (right) in the CIE color space.

FIG. 3c is a graph of reflection (normalized) vs. wavelength in nm of 18 test colors printed on an eGFP silk fibroin print sheet at the opacity of 40%. Each color of the lines means the corresponding 18 test colors.

FIG. 3d is a plot of chromaticity in the CIE color space of 18 colors at an opacity of 100% and 40%.

FIG. 3e provides photographs of representative printouts for watermarked images on eGFP silk fibroin print sheets including i) color wheel, ii) flower, iii) baboon, iv) Lena, and v) Barbara.

FIGS. 3f, 3g, and 3h are schematics of an alignment correction scheme whereby alignment patterns are provided in the image that is acquired by the smartphone and how these patterns are used to correct rotation of the acquired image.

FIG. 4a is a schematic of a print-camera process that introduces color distortions, according to the present disclosure.

FIG. 4b is a schematic of a watermarked image, whereby a set of 32 primary colors that are printed on the border of the watermarked image serves as reference colors to correct distorted colors from the print-camera process.

FIGS. 4c and 4d are representative input 32 CIE RGB colors for printing (FIG. 4c) and the resultant colors acquired through the print-camera process (FIG. 4d), where FIG. 4e represents corrected color values obtained from a leave-one-out cross-validation process, according to the present disclosure, and FIG. 4f represents a scatter plot of the input International Commission on Illumination (CIE) RGB (FIG. 4c) and corrected (FIG. 4e, see below) color values in each RGB channel.

FIG. 4e represents corrected color values obtained from the leave-one-out cross-validation, according to the present disclosure.

FIG. 4f represents a scatter plot of the input CIE RGB (FIG. 4c) and corrected (FIG. 4e) color values in each RGB channel.

FIGS. 4g, 4h, and 4i represent root mean square relative error (RMSRE) between the input CIE RGB color values and corrected color values in different acquisition conditions, where the RMSRE between the input CIE RGB color values and color values in the case without the color correction are examined for comparison.

FIGS. 4j and 4k are schematics of processes of watermark image embedding (FIG. 4j) and extraction (FIG. 4k), according to the present disclosure.

FIG. 5a provides photographs which show representative cases in which different watermark images embedded in the same host image result in indistinguishable watermarked images to the naked eye.

FIG. 5b provides photographs which show how five smartphone models are employed to acquire a watermarked taggant under an illumination color temperature of 5800 K and an optical intensity of 3.1 W m⁻², where the image acquisitions are performed 12 times.

FIG. 5c is a scatter plot of structural similarity indices between the original digital (input) watermark image and the extracted watermark image from the edible watermarked taggant via the print-camera scheme for the five smartphone models.

FIG. 5d is a scatter plot of structural similarity indices between the original digital (input) watermark image and the extracted watermark image from an edible watermarked taggant produced by a simulated copy (scan-print) attack.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is presented herein to provide dosage-level or item-level (collectively, on-dose) anticounterfeit measures and authentication features that can provide protection against counterfeited pharmaceutical and food-related products. Towards this end, each product can be verified and authenticated even if it is separated from its package. Patients and consumers can identify their medicines and food product in real time with important dose information and food product history such as location of origin, date of manufacture or harvest, intermediate handling, etc. at the point of administration or consumption. Furthermore, such on-dose authentication for individual medicines or food products allows patients or consumers to serve as the last line of defense and actively participate in combating the prevalence of illicit pharmaceutical and food-related products. In addition, companies can implement serialization directly to individual medicines and food products, thereby enabling the tracking and tracing of medicines and foods to ensure safety, quality, and brand protection.

To implement the above-referenced on-dose features, it is necessary to ensure the nontoxicity and edibility (or digestibility) of constituent materials without compromising the safety or introducing interactions with main ingredients. Another requirement of on-dose features is a physical form because the security measure is directly applied to the solid oral dosage form (e.g. pill, tablet, or capsule) or affixed to the individual medicine, or food product. Among encryption and steganography methods, digital watermarking provides an immediately available security solution for copyright protection, identification, and authentication. The use of digital watermarking to protect medical images and diagnostic results has been widely recommended. However, as a purely digital process, digital watermarking does not involve any physical form. Physical watermarking, which has been extensively used for high-value objects (e.g. currency, document, and artwork) to discourage and identify counterfeiting, lacks digital and cyber aspects.

In the present disclosure, we introduce edible print-camera watermarking by combining the digital and physical properties of watermarking to establish anticounterfeit measures and authentication features at the dosage level (i.e., individual pharmaceutical or food product level) instead of the secondary package level. First, we refine an inkjet printing method to use FDA-approved food coloring as edible ink. Examples of edible ink are many, however several are provided in patent references including WO1998029514A1, WO2005122784A1, US20050061184A1, WO2004003089A1, and JP2001011355A, each of which is incorporated by reference in its entirety into the present disclosure. Inkjet printing is scalable for printing edible materials and can be implemented for additive manufacturing. Second, as an edible and digestible natural biopolymer, we use fluorescent protein, e.g., silk fibroin genetically hybridized with enhanced green fluorescent protein (eGFP) to fabricate an attack-resistant print sheet. Fluorescent substrate is a robust attack-resistant material since it shows unique optical properties that have absorption and emission in visible light (wavelength range of 400-700 nm). As another candidate, a colored material also can protect against a copy or scan attack because it has light absorption at visible wavelengths of 400-700 nm. In other words, such materials with light absorption and/or emission work as an attack-resistant factor during scanning based on white light for a copy of the original watermarked image. Third, we enhance the robustness of digital watermark extraction against significant color distortions that occur during the print-camera process. In particular, an integrated color correction using reference colors printed on a watermarked taggant is developed to ensure the reliability of edible watermarked taggants under scenarios involving different smartphone models and light conditions. Finally, for the edible watermarked taggants affixed to individual solid oral dosage forms, we investigate the readout repeatability of the watermark extractions and printing reproducibility of statistically identical watermarked taggants.

Thus, an inkjet printer using safe food coloring is adapted to print a watermarked image on a recombinant luminescent taggant to enhance attack resistance. Machine learning of color accuracy recovers unavoidable color distortions during printing and acquisition, allowing robust smartphone readability. An edible watermarked taggant affixed to each individual medicine or food product can offer anticounterfeit and authentication features at the dosage level, empowering every patient and consumer to aid in abating illicit medicines and food products.

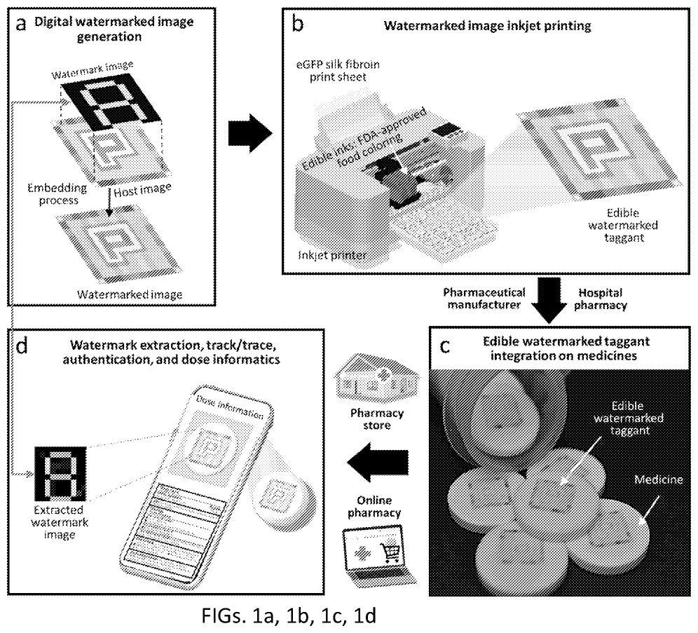

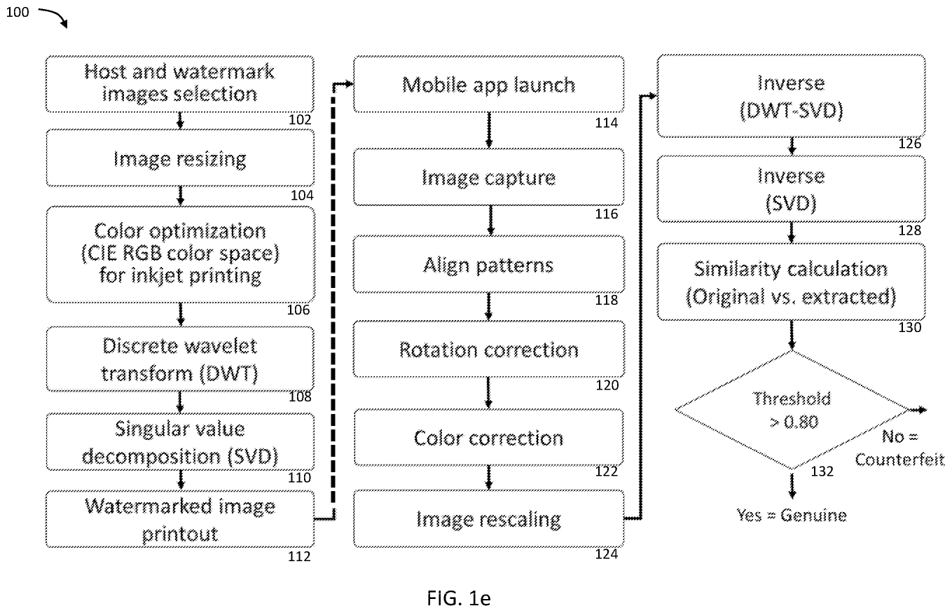

Referring to FIGS. 1a, 1b, 1c, 1d, schematics of the basic steps of the present disclosure are depicted. Specifically, processes involved in a digital watermarked image generation are shown. A fluorescent image (in the present disclosure, fluorescence refers to material that can absorb light at a first wavelength band, be excited and then emit light at a second wavelength band. The watermark image is overlaid (i.e., embedded) on a host image made of edible FDA-approved ink that is printed on a substrate. The printing process is shown in FIG. 1b, which shows an inkjet printing of the digital watermarked image using FDA-approved food coloring (i.e. edible ink) on a natural fluorescent biopolymer print sheet. All the constituent materials (i.e. fluorescent protein, silk fibroin protein, and FDA-approved food coloring dye) are safe for oral consumption. The printed watermarked image combination is then cut and used a taggant for the product by attaching the taggant to the product as shown in FIG. 1c. The product with the attached taggant can be on-dose authenticated by using a smartphone as shown in FIG. 1d. The degree of structural similarity index between the original digital watermark image and extracted watermark image can be evaluated for verification. Upon authentication, dose and track/trace information can be shared with the patient. It should be noted that the host image may include a color chart on the border of the taggant which as described below can be used to preform color-correction in a calibration process.

Thus, FIGS. 1a-1d present the process flow of the edible watermarking scheme of the present disclosure. As alluded to above, a digital watermark image is embedded into a host (or cover) image via discrete wavelet transform (DWT) and singular value decomposition (SVD), known to a person having ordinary skill in the art, thereby generating a digital watermarked image (see FIG. 1a). Next, the digital watermarked image combination is printed on an edible biopolymer print sheet (i.e., substrate) using a commercially available inkjet printer with FDA-approved food coloring (i.e. edible ink) (see FIG. 1b). To ensure tamper resistance (e.g. copy attack), a protein-based print sheet composed of a fluorescent agent, e.g., a fluorescent silk fibroin, e.g., eGFP, which is incorporated into the inkjet printing process. In other words, if a counterfeiter attempts to copy the watermarked image using, e.g., a scanner, deploying white light, the emission from the fluorescent agent results in an image that is different than the image that is printed on the substrate (for example using eGFP the emitted image will have a green hue), making such tamper-resistant product difficult to copy for counterfeiting purposes. Next, each product in a solid oral dosage form (e.g. pill, tablet, or capsule) is integrated with the watermarked taggant by the pharmaceutical manufacturer or a pharmacy (see FIG. 1c). Next, before oral intake, an end user (e.g. a patient) scans the watermarked taggant affixed to the product by using a smartphone to authenticate the product and access important dose information (e.g. dosage strength, dose frequency, and interactions with other common medicines), manufacturing details (e.g. brand name, manufacturing and expiration date, and lot number), and distribution path (e.g. country, distributor, wholesaler, and supply chain) (See FIG. 1d). Referring to FIG. 1e, a flowchart of a process 100 according to the present disclosure is provided that outlines the steps discussed above in a more detailed manner. As provided in FIG. 1e, as an initial step a host and watermark images are selected to be processed as discussed above. Next, the watermark and the host images are resized for proper sizing, as provided in step 104. Next, a color optimization process is undertaken as shown by 106 based on the International Commission on Illumination (CIE) color space, for inkjet printing. It should be noted that while inkjet printing is described herein, other methods of printing known to a person having ordinary skill in the art in which a printing process is adapted to print color images on a substrate using all-consumable (i.e., edible) materials can be used in place of inkjet printing. As part of the step 106, a border around the watermarked image is printed that can be used to calibrate the acquisition process as discussed below. Next a discrete waveform transform (DWT) process 108 and a singular value decomposition (SVD) 110, both known to a person having ordinary skill in the art are used to incorporate the watermark image into the host image (collectively the watermarked image). Specifically, the original watermark is referred to herein as either the watermark or the watermark image, while the combination of the watermark and the host is referred to herein as the watermarked image. Next, the watermarked image is printed as provided in step 112 using an inkjet process, or other alternative processes as discussed herein. Thereafter, the printed watermarked image is cut and affixed to a product that is to be protected from counterfeiting. The product is shipped and received by a consumer. The consumer prior to consumption of the product, determines the authenticity of the product as provided herein. Specifically, the consumer launches an application on his/her smartphone as provided in step 114. Next, the smartphone is used to capture an image of the affixed printed watermarked image as provided in step 116. Next, the captured image is aligned (step 118) and corrected for rotation (step 120) before using the border color chart to carryout a color correction (i.e., calibration) a shown in step 122. Next the image is rescaled (step 124) and inverse DWT and SVD processes are carried out (steps 126 and 128) to extract the watermark image. The extracted watermark image is then compared to a previously communicated watermark image from the originator of the product and similarities between these images are determined as a comparison between the original and the extracted watermark image (step 130). If the similarity is higher than a predetermined threshold (e.g., 80%), the smartphone application deems the product to be authenticated as genuine, else, deemed as counterfeit (step 132).

As alluded to above, to ensure resistance to a copy (scan-print) attack, a fluorescent material, e.g., a biopolymer, is used to make a print sheet on which the edible watermarked image (i.e., the watermark image and the host image) is printed. There are many such edible fluorescent materials. One such example, is silk proteins genetically fused with eGFP which provide several advantages. From an edibility standpoint, silk fibroin is not only biocompatible with low immunogenicity and minimal inflammatory responses, but is also generally recognized as safe as designated by FDA (i.e., Generally Recognized as Safe (GRAS)). The commonly applied silk fibroin extraction method does not introduce heavy metals and toxic trace elements. Moreover, silk fibroin is easily digestible in the presence of proteolytic enzymes (e.g. pepsin or trypsin) produced in the gastrointestinal tract. Fluorescent proteins are often consumed as genetically modified dietary products. In addition, eGFP does not have common allergen epitopes. From a manufacturing standpoint, the genetic fusion (i.e. eGFP silk fibroin) of silk fibroin and eGFP can be readily realized via the piggyBac transposon method or clustered regularly interspaced short palindromic repeats (CRISPR) methods, both known to a person having ordinary skill in the art, which allow mass, scalable, and sustainable production.

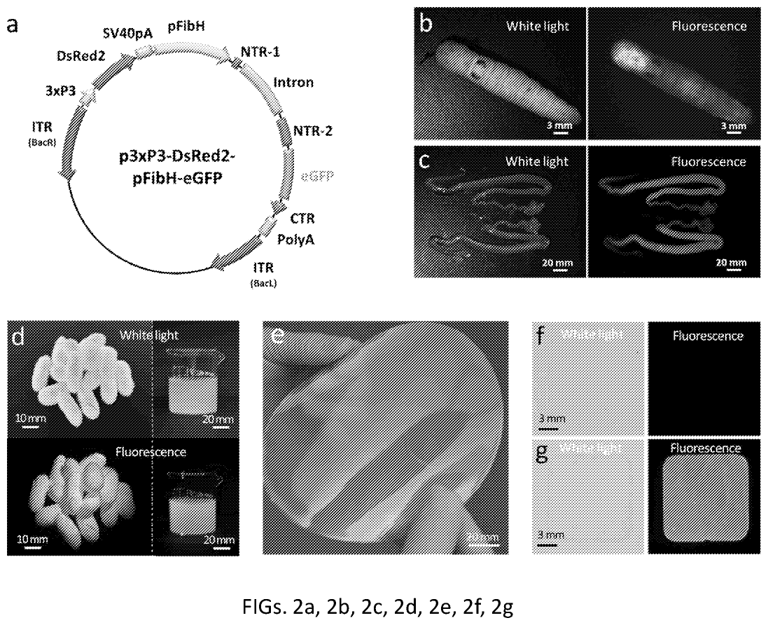

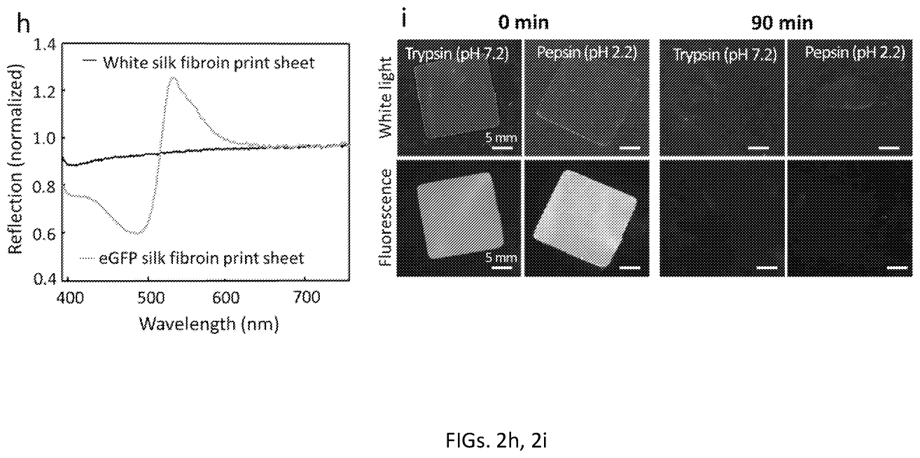

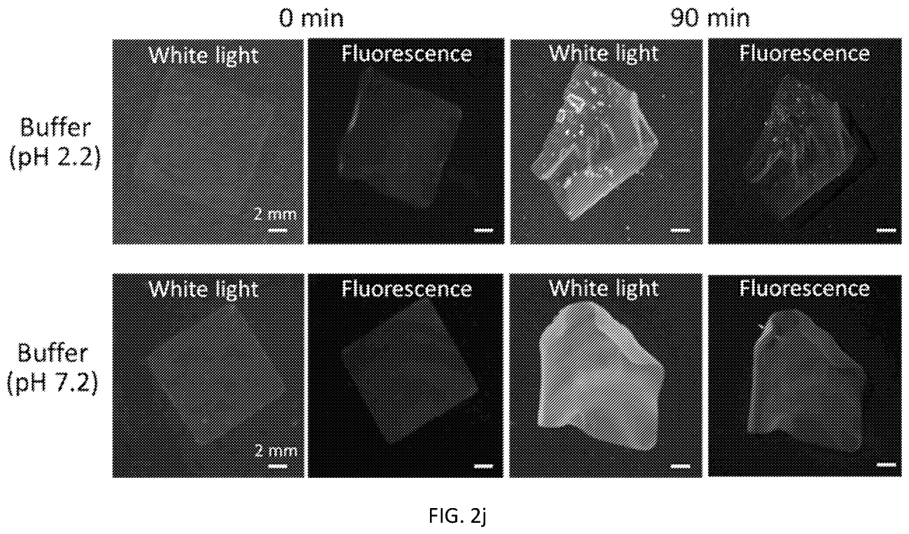

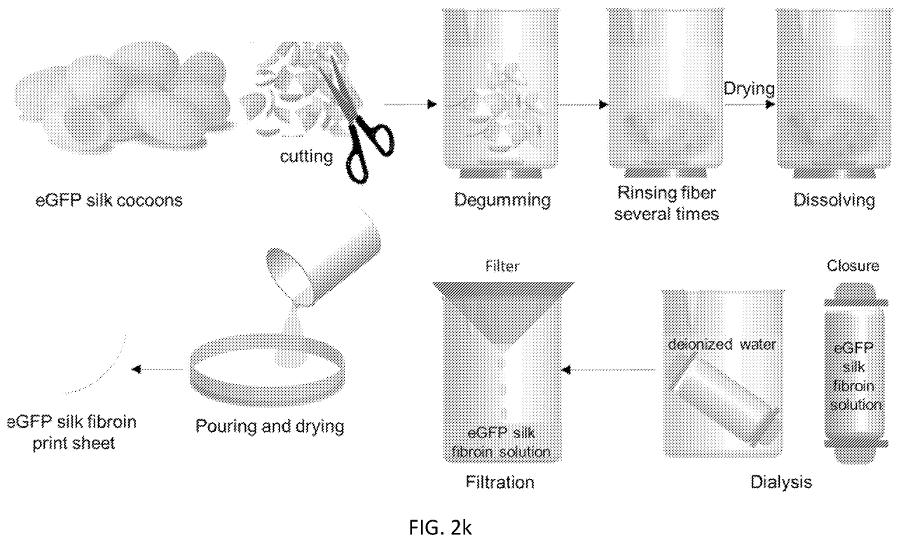

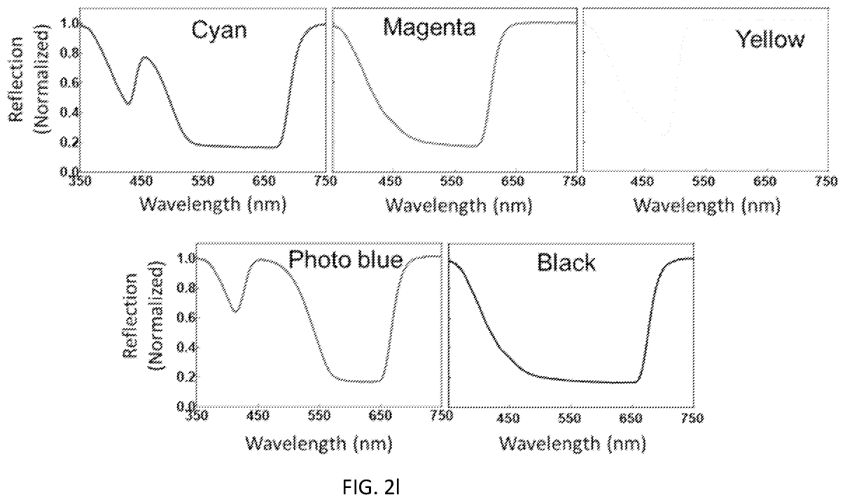

To produce eGFP silk, we fuse the eGFP gene with the N-terminal and C-terminal domains of the silk fibroin heavy (H)-chain promoter (pFibH) using the piggyBac transposon method, creating a p3×P3-DsRed2-pFibH-eGFP transformation vector, as shown in FIG. 2a. Specifically, FIG. 2a shows a schematic of a transformation vector p3×P3-DsRed2-FibH-eGFP for eGFP-expressing silk production by the piggyBac transposon method. The vector includes fibroin heavy chain promoter domain (pFibH, 1124 bp), the N-terminal region 1 (NTR1, 142 bp), first intron (Intron, 871 bp), the N-terminal region 2 (NTR2, 417 bp), C-terminal region (CTR, 179 bp), poly (A) signal region (PolyA, 301 bp), eGFP (720 bp), inverted repeat sequences of piggyBac arms (ITR), 3×P3 promoter, and SV40 polyadenylation signal sequence (SV40 pA). This transition vector is injected with a helper vector into the pre-blastoderm embryos of silkworms to produce transgenic eGFP silkworms that spin eGFP silk fibers (as shown in FIGS. 2b, 2c, and 2d). In particular, FIGS. 2b and 2c are photographs and fluorescence images of a transgenic eGFP silkworm (FIG. 2b) and silk gland (FIG. 2c). FIG. 2d provides photographs and fluorescence images of eGFP silk cocoons and extracted eGFP silk fibroin solutions. The green fluorescence image is obtained using an optical set of excitation (λₑₓ=470 nm) and emission (λₑₘ=525 nm). As shown in FIG. 2d, the eGFP silk cocoons are processed into an eGFP silk fibroin solution by minimizing the heat-induced denaturation of eGFP in silk proteins. The natural color of eGFP silk is yellow, and the strong green fluorescence emission can be readily detected using an optical set of excitation (λₑₓ=470 nm) and emission (λₑₘ=525 nm). The intact fluorescence signals also support the idea that the chromophore of eGFP in silk is not damaged during the regeneration process. A large-area print sheet of the eGFP silk fibroin can be fabricated with scalability (see FIG. 2e which is a photograph of a large-area eGFP silk fibroin sheet with a diameter of 150 mm and thickness of 75±5 μm). A print sheet with a size of 140×140 mm² is fed into an inkjet printer to print a large number of edible watermarked taggants. Compared to nonfluorescent white silk fibroin, the reflectance spectral profile of the eGFP silk fibroin print sheet is not monotonous in the visible range owing to its absorption at the blue wavelength and emission at the green wavelength (see FIGS. 2f and 2g which are photographs and fluorescence images of typical white silk (FIG. 2f) and eGFP silk (FIG. 2g) fibroin print sheets). Only the eGFP silk fibroin print sheet exhibits green fluorescence emission at λₑₓ=470 nm and λₑₘ=525 nm. This spectral characteristic is shown in FIG. 2h which is a graph of reflection (normalized) vs. wavelength in nm showing a comparison white silk (i.e., non-fluorescent silk) fibroin print sheet and eGFP silk fibroin print sheet which can serve as a tamper-resistant feature for a scan-print attack when a scanner or copier is used to attempt to duplicate a watermarked image. Enzymatic digestibility of eGFP silk fibroin print sheets are shown in FIG. 2i which are photographs and fluorescence images of eGFP silk fibroin sheets immersed in physically relevant pepsin (pH 2.2) enzyme or trypsin (pH 7.2) enzyme solutions, obtained at 0 and 90 min, respectively.

Specifically, to examine the digestibility of edible watermarked taggants, the enzymatic degradation and denaturation of eGFP silk proteins are investigated using two major proteolytic enzymes (i.e. pepsin and trypsin) produced in the gastrointestinal tract under physiologically relevant conditions. Notably, eGFP fluorescence can serve as a biomarker for quantifying protein denaturation and degradation, because the protein unfolding of the eGFP chromophore from proteolytic enzyme exposure or any damage in the tertiary structure results in a loss of fluorescence. After immersing the eGFP silk fibroin print sheets into each enzyme solution, we monitor the fluorescence emission intensity of eGFP at 525 nm upon 470-nm excitation. Compared to that associated with the pH 2.2 and pH 7.2 buffer solutions, the fluorescence of the eGFP silk fibroin print sheets immersed in 0.25% trypsin (pH 7.2) and 0.1% pepsin (pH 2.2) enzymes is considerably decreased after 90 min. In other words, the protein-based print sheet can be easily digested in the gastrointestinal tract after oral intake.

Referring to FIG. 2j, photographs and fluorescence images of eGFP silk fibroin print sheets immersed in buffer solutions with the same pH values without proteolytic enzymes are shown. Fluorescence images of the eGFP silk fibroin print sheets are captured through an optical emission filter of 525 nm under 470-nm illumination at two time points of 0 and 90 min. The fluorescent silk fibroin print sheets still maintain the strong fluorescence emission after 90 min, despite cloudy swelling and shape distortion, because no significant degradation or denature occurs.

The fabrication process of the eGFP silk fibroin, according to one embodiment, is shown in FIG. 2k. Specifically, steps for composing a fluorescent print sheet composed of eGFP fluorescent silk fibroin extracted from transgenic eGFP silkworm cocoons are shown. eGFP silk cocoons are cut into small pieces and undergo sericin removal (i.e. degumming), and then are washed with deionized water. The dried eGFP silk fibers are dissolved. After dialysis and filtering of the dissolved eGFP silk fibroin solution, a pure eGFP silk fibroin solution is poured on a plastic petri dish and is cast under ambient conditions in the dark for three days, thereby producing the eGFP silk fibroin print sheet.

To fabricate safe edible watermarked taggants for on-dose applications, we use commercially available FDA-approved food coloring dyes formulated in a food-grade laboratory. These edible dyes have the appropriate physical properties (e.g. viscosity <16 mPa·s) to be compatible to inkjet printer ink. Inkjet printing is an attractive option to ensure the scalable printing of edible taggants and can potentially be integrated into an additive pharmaceutical manufacturing process. However, it is challenging to print images or patterns using these edible coloring dyes on an eGFP silk fibroin print sheet. Edible coloring dyes were originally developed for frosting sheet printing. The inkjet printing ability is affected by the surface properties of print sheets. It should be noted that the surface of eGFP silk fibroin films is water repellent. The main ingredients of each color ink solution and the corresponding Food, Drugs and Cosmetics (FD&C) color information are provided in Table 1.

TABLE 1
Main ingredients of each color ink solution and the corresponding FD&C color information

| | | | | Photo blue | |
|---|---|---|---|---|---|
| Color | Cyan (C) | Magenta (M) | Yellow (Y) | (PB) | Black (BK) |
| Ingredient | FD&C Blue | FD&C Red | FD&C Yellow | FD&C Blue | FD&C Red |
| | No. 1 <1% | No. 3 <1% | No. 5 <1% | No. 1 <1% | No. 3 <1% |
| | Water 93% | Water 93% | FD&C Red | FD&C Red | FD&C Blue |
| | Alcohol 3% | Alcohol 3% | No. 3 <1% | No. 3 <1% | No.1 <1% |
| | | | Water 93% | Water 93% | FD&C Yellow |
| | | | Alcohol 3% | Alcohol 3% | No. 5 <1% |
| | | | | | Water 93% |
| | | | | | Alcohol 3% |

Referring to FIG. 2l, graphs of reflection (normalized) vs. wavelength in nm are provided for color and spectral characteristics of FDA-approved food coloring dyes. Each reflection spectrum was measured using a fiber-coupled spectrophotometer coupled with a xenon lamp after diluting food coloring solutions with deionized water (1:100), normalized by a white reflectance standard with a reflectivity of 99% (AS-01160-060, Labsphere).

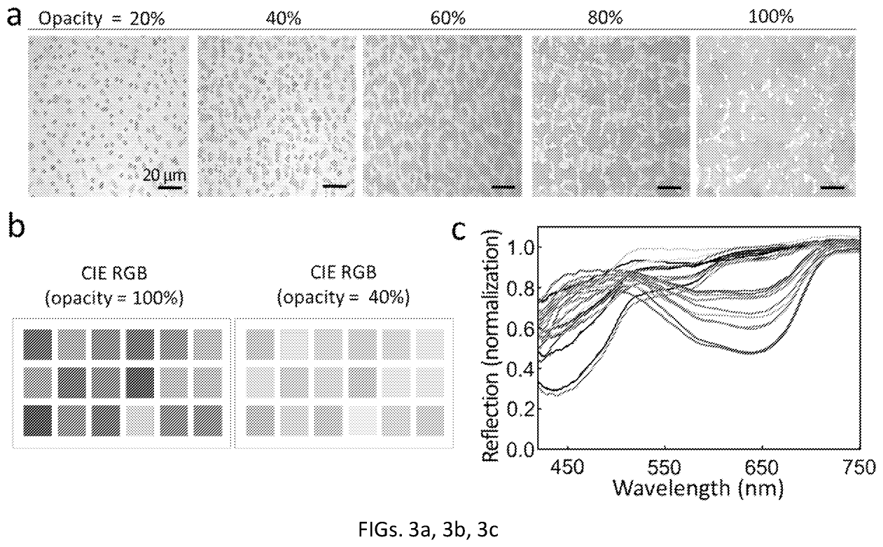

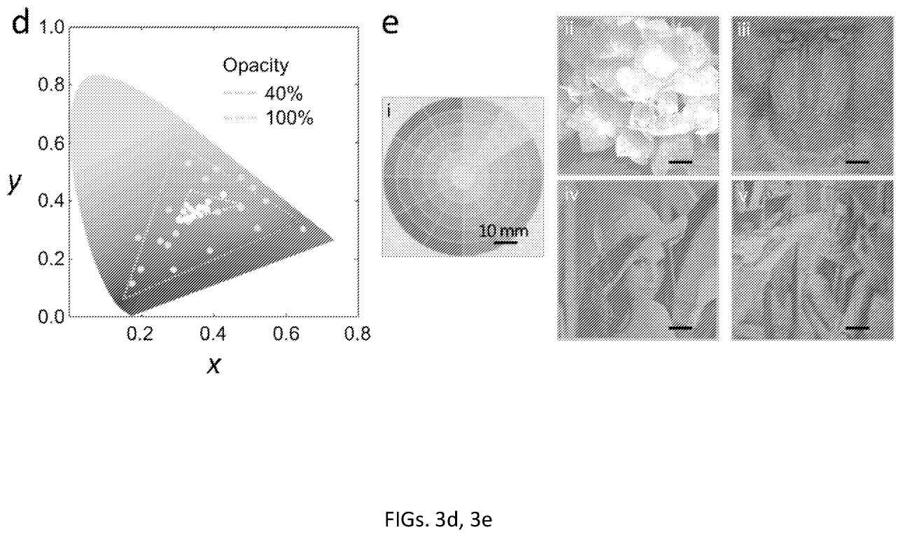

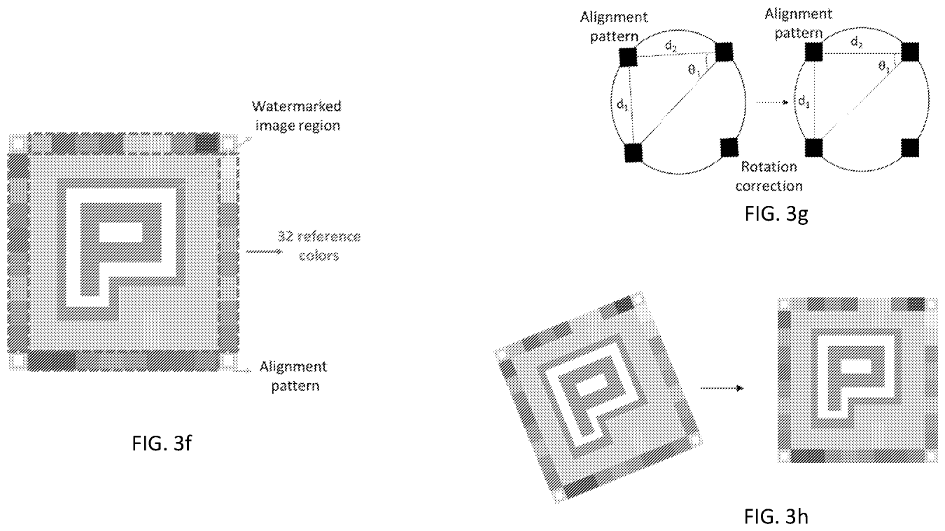

The optimal density of droplets in the proposed inkjet printing method (also known as halftoning in inkjet printing) was determined. A simple square pattern with a green color is printed using the food coloring dyes on eGFP silk fibroin sheets at opacity levels ranging from 20 to 100% in the CIE RGB space (see FIG. 3a which are microscopic photographs of inkjet droplet wetting of FDA-approved food coloring (green color) on eGFP silk fibroin print sheets). The opacity of 40% is optimal for the proposed inkjet printing owing to the spontaneous spreading and wetting of droplets). At the low opacity level of 20%, the droplets jetted through the inkjet printer are partially wetted and maintain their shape; however, the RGB colors are not clear owing to the low density of droplets, as shown in the spectra. In contrast, the microscopic examinations above 60% show that the droplets are merged and spontaneously spread to adjacent droplets, resulting in color blots Thus, we set the optimal opacity level as 40% to maintain the unique spectral profiles of 18 test colors (see FIG. 3b which are photographs of a representative of 18 test colors with an opacity of 100% (left) and 40% (right) in the CIE color space, and see FIG. 3c which is a graph of reflection (normalized) vs. wavelength in nm of 18 test colors printed on an eGFP silk fibroin print sheet at the opacity of 40%. Each color of the lines means the corresponding 18 test colors). The chromaticity in the CIE color space reduces when the measured reflection spectra are converted into the CIE RGB values (see FIG. 3d which is a plot of chromaticity in the CIE color space of 18 colors at an opacity of 100% and 40%). The gamut of the 18 test colors at the opacity of 40% (yellow dotted triangle) is smaller than that at 100% (cyan dotted triangle), this level of opacity ensures a reliable printing quality). Several images printed at an opacity of 40% confirm the printability of the proposed edible inkjet printing for maintaining vivid colors (see FIG. 3e which are photographs of representative printouts for watermarked images on eGFP silk fibroin print sheets: i) color wheel, ii) flower, iii) baboon, iv) Lena, and v) Barbara).

To extract the embedded watermark image from image acquired by the smartphone, it is critical to correct color artifacts and geometrical distortions that occur during printing and image acquisition. Both geometrical distortion realignment and color correction are needed (steps 118, 120, and 122 shown in FIG. 1e) for the acquired image. The geometrical distortion realignment is performed based on alignment patterns which are used for correcting geometrical rotation. After detecting a plurality of alignment patterns (e.g., four such alignment patters), three parameters of two lines (d₁ and d₂) and an angle (θ₁) are extracted for a reliable geometric correction. Referring to FIGS. 3f, 3g, and 3h schematics of an alignment correction scheme are shown whereby alignment patterns are provided in the image that is acquired by the smartphone and how these patterns are used to correct rotation of the acquired image. Once the alignment is corrected, then colors are corrected.

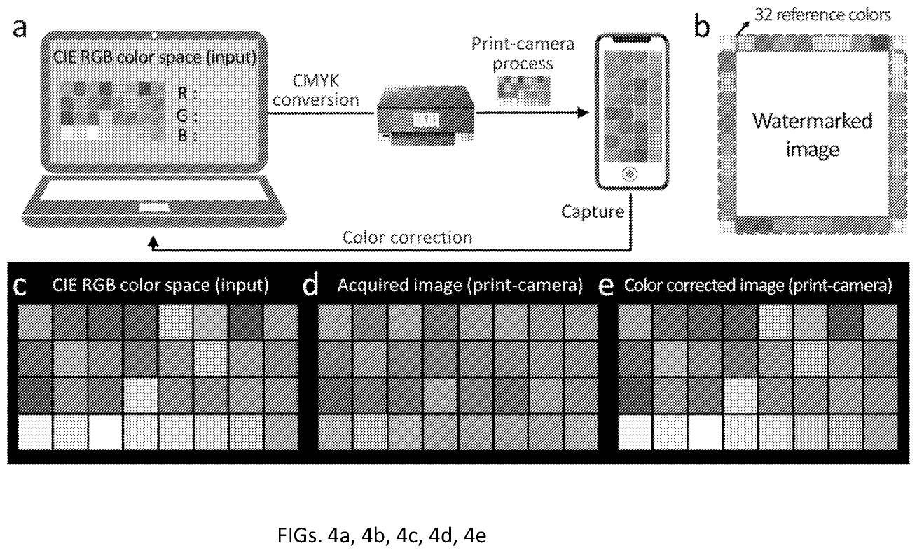

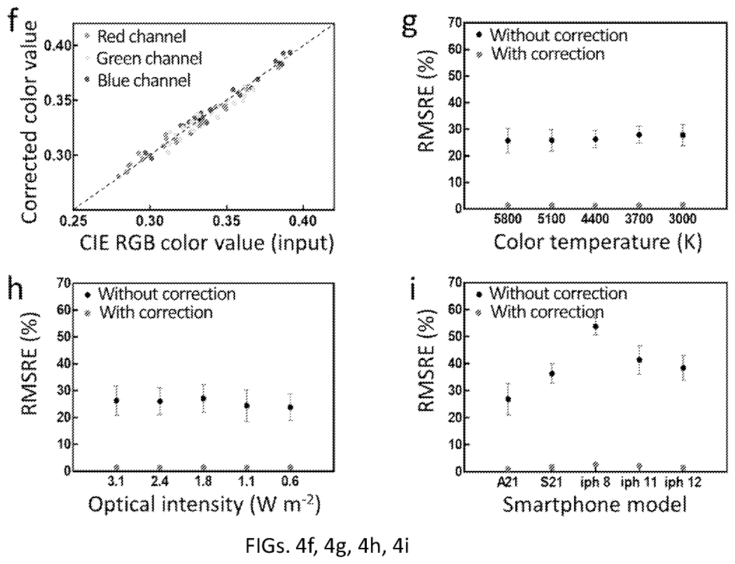

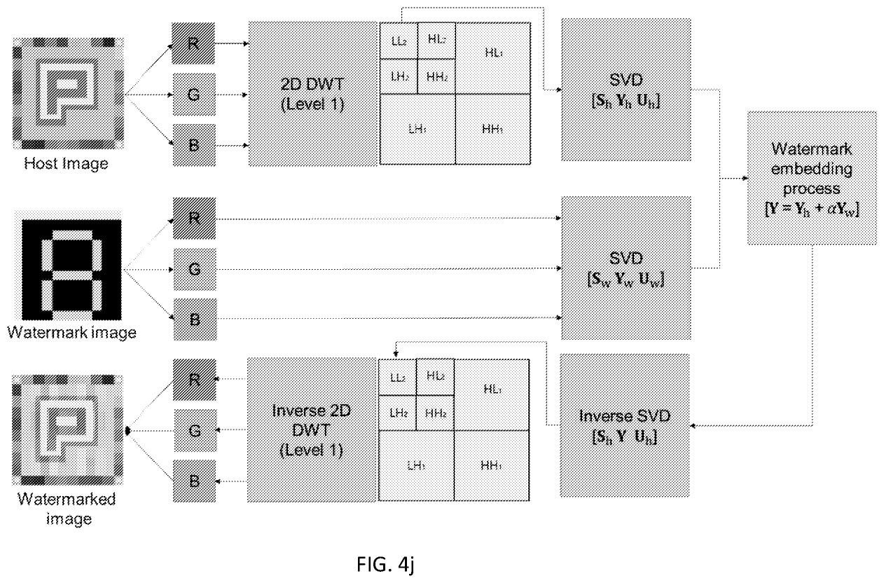

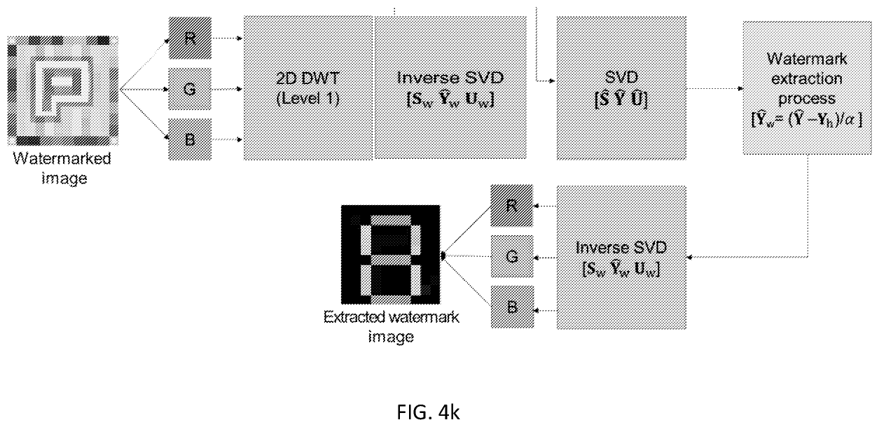

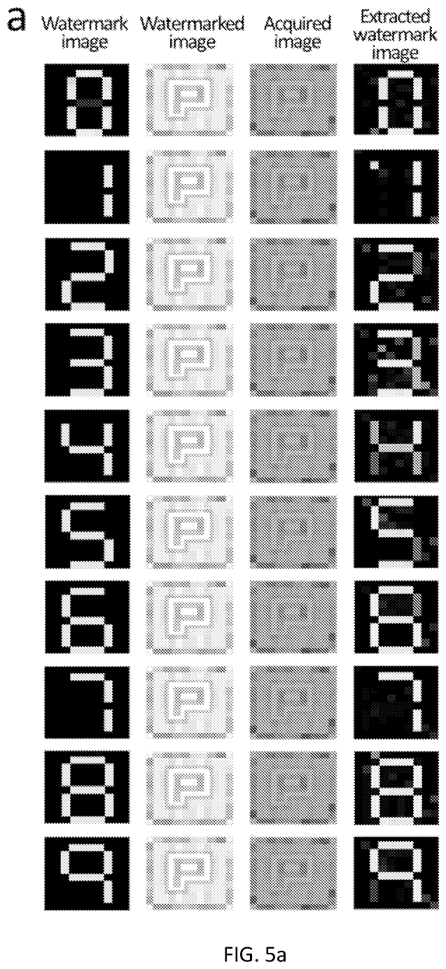

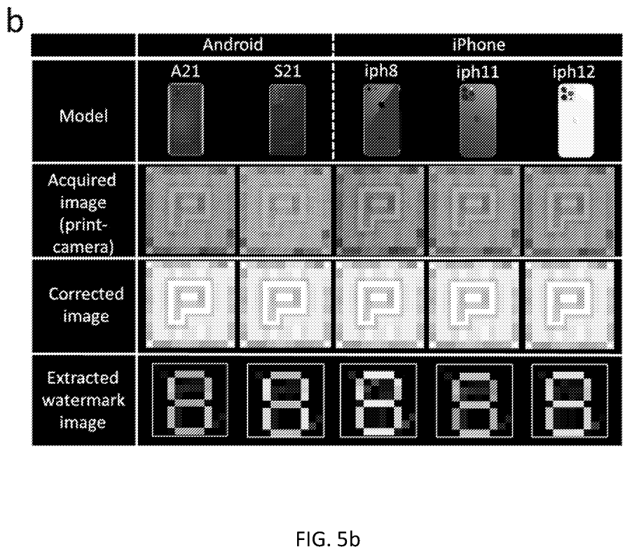

Photographs obtained using a smartphone camera or any digital camera exhibit different colors and brightness depending on the models and ambient light conditions during such image acquisition. In particular, each digital camera and smartphone model (i.e. three-color image sensors or trichromatic cameras) has unique spectral response functions (also known as spectral sensitivity) in the red (R), green (G), and blue (B) channels. A white balance is often used to adjust colors to represent a natural appearance; however, this aspect is not sufficient to compensate for color distortions. Notably, print-camera watermarking involves not only imaging but also printing, both of which are intrinsically lossy processes for color integrity. This color correction is shown in FIGS. 4a-4i (schematics showing color correction of the acquired image).

In particular, FIG. 4a is a schematic of a print-camera process that introduces color distortions. A set of 32 primary colors printed on the border of the watermarked image serves as reference colors to correct distorted colors from the print-camera process as provide in FIG. 4b. FIGS. 4c and 4d are representative input 32 CIE RGB colors for printing (FIG. 4c) and the resultant colors acquired through the print-camera process (FIG. 4d). FIG. 4e represents corrected color values obtained from leave-one-out cross-validation, discussed below. FIG. 4f represents a scatter plot of the input CIE RGB (FIG. 4c) and corrected (FIG. 4e) color values in each RGB channel. The line shown is a linear regression fit. The color correction matrix converts the acquired color values to the original CIE RGB space. FIGS. 4g. 4h, and 4i represent root mean square relative error (RMSRE) between the input CIE RGB color values and corrected color values in different acquisition conditions. The RMSRE between the input CIE RGB color values and color values in the case without the color correction are examined for comparison. Specifically FIG. 4g is the RMSRE as a function of the color temperature at an optical intensity of 3.1 W m⁻², FIG. 4h is the RMSRE as a function of the optical intensity at a color temperature of 5800 K. with the images acquired by an Android smartphone (SAMSUNG GALAXY™ S21), and FIG. 4i is the RMSRE as a function of the smartphone model (SAMSUNG GALAXY™ S21, SAMSUNG GALAXY™ A21, APPLE™ iPhone 8, APPLE™ iphone 11 Pro, and APPLE™ iPhone 12 Pro) at a color temperature of 5800 K and an optical intensity of 3.1 W m⁻². The error bars represent one standard deviation.

To recover the true RGB color values significantly distorted during printing and image acquisition, we incorporate machine learning of fixed-design regression in which polynomial features capture a nonlinear relationship between the original CIE and acquired RGB color values resulting from diverse spectral responses (or sensitivity) functions of different smartphone models. Specifically, we implement a color correction methodology by adding 32 primary colors into the periphery of a watermarked image (see FIG. 4b in which the color pallet is shown on the border of the watermarked image). First, the relationship between the original (input to the printer) CIE RGB color values of the 32 primary colors and the measured RGB color values in the print-camera process can be expressed as:

$$T = C M \qquad ( 1 )$$

where T and M are 3×m matrices of the original CIE and measured RGB color values for m (e.g., 32) primary colors, respectively. By solving Equation (1) for the unknown matrix C, C can be used to convert the measured RGB color values of a watermarked image to the CIE RGB color space. First, we use the CIE RGB color space as a reference space because the CIE RGB color space defines physiologically perceived colors in the human visual system on the basis of the electromagnetic spectrum, and other color spaces are often derived from the CIE RGB (or XYZ) color space. Second, to incorporate nonlinearity between the original CIE and measured RGB color values, M_{3×m} can be expanded to M_{p×m} based on:

$${T}_{3 \times m} = {C}_{3 \times p} {M}_{p \times m} \qquad ( 2 )$$

where the p rows in M_{p×m} include the polynomial terms and cross-terms in addition to the RGB color values (see the Experimental Section). Third, an inverse of the expanded conversion matrix C in Equation (2) can be solved using a least-squares method (i.e. I₂-norm minimization), such as QR decomposition or Moore-Penrose pseudo inverse.

Next, we evaluate the color correction ability of representative print-camera cases through leave-one-out cross-validation (see FIGS. 4c-4e), in which matrix C is obtained from the complete dataset (31 colors) excluding one color among the 32 primary colors and a prediction is made for the excluded color to construct Equation (2). This process is repeated 32 (m) times and the predicted RGB color values exhibit excellent agreement with the actual RGB color values, resulting in a determination coefficient (R2) of 0.96 (see FIG. 4f which is a graph of corrected color value vs. CIE RGB color value used as input). The root mean square relative error (RMSRE) between the original CIE RGB and corrected color values (see the Experimental Section, Supporting Information) is used to evaluate the color correction performance in a variety of data acquisition conditions, such as diverse light conditions, different levels of color temperature and optical intensity, and different smartphone models (see FIGS. 4g-4i, which are graphs of RMSRE (%) vs. optical intensity in W m²). Specifically, the color temperature and optical intensity are varied from 3000 to 5800 K at a constant optical intensity of 3.1 W m⁻² and from 0.6 to 3.1 W m⁻² at a color temperature of 5800 K, respectively, and image acquisition is performed using an Android smartphone (SAMSUNG GALAXY™ S21) (see FIGS. 4g and 4h). Moreover, five smartphone models (i.e. Android and iPhone) are used to acquire watermarked images at 5800 K and 3.1 W m⁻² (See FIG. 4i, which is a graph of RMSRE (%) vs. smartphone model). After the color correction, the averaged RMSRE values are significantly lower than those without the color correction, e.g., see Table 2 showing the reliability of the integrated color correction method under different acquisition conditions.

TABLE 2
Color correction performance under a variety of data acquisition conditions

| | | RMSRE values | | RMSRE values | |
|---|---|---|---|---|---|
| | | without color correction | | with color correction | |
| Acquisition condition | | | Standard | | Standard |
| Variable | Condition | Mean | deviation | Mean | deviation |
| Color | 5800 | 25.71 | 4.63 | 1.92 | 0.25 |
| temperature | 5100 | 25.91 | 4.05 | 1.93 | 0.36 |
| (K) | 4400 | 26.34 | 3.20 | 1.85 | 0.31 |
| | 3700 | 28.01 | 3.14 | 1.88 | 0.30 |
| | 3000 | 27.84 | 3.94 | 2.08 | 0.28 |
| Optical | 3.1 | 26.30 | 5.47 | 1.91 | 0.14 |
| intensity | 2.4 | 26.07 | 4.97 | 1.94 | 0.29 |
| (W m⁻²) | 1.8 | 27.09 | 5.20 | 1.97 | 0.27 |
| | 1.1 | 24.42 | 5.82 | 1.92 | 0.13 |
| | 0.6 | 23.85 | 4.93 | 1.97 | 0.31 |
| Smartphone | GALAXY ™ A21 | 26.89 | 5.76 | 1.75 | 0.69 |
| model | GALAXY ™ S21 | 36.34 | 3.62 | 2.53 | 0.92 |
| | IPHONE ™ 8 | 53.84 | 3.21 | 3.24 | 0.28 |
| | IPHONE ™ 11 Pro | 41.31 | 5.28 | 2.71 | 0.27 |
| | IPHONE ™ 12 Pro | 38.47 | 4.53 | 2.23 | 0.80 |

The watermark image is next extracted from the acquired image after the realignment and the color correction, discussed above. To evaluate the accuracy of watermark image extraction, we use a structural similarity index that can comprehensively quantify the image luminance, contrast, and structural pattern in comparison with the original watermark. Referring to FIGS. 4j and 4k, schematics of watermark image embedding (FIG. 4j) and extraction (FIG. 4k) are shown. Specifically, in the watermark embedding process shown in FIG. 4j, a host image in each RGB channel is separately decomposed into subbands of single-level 2D discrete wavelet transform (DWT). Singular value decomposition (SVD) is performed on LL₂ subband, generating [Sₕ Yₙ Uₕ]. The watermark image in each RGB channel is separately decomposed by SVD only, generating [S_{w} Y_{w} U_{w}]. The watermark image is embedded into the host image with a scale factor a such that Y=Yₕ+αY_{w}. To form a resultant watermarked image, Yₙ is replaced with Y, and an inverse process of 2D DWT-SVD is conducted. The watermark can be extracted as shown in FIG. 4k, where the watermarked image acquired by a smartphone camera is decomposed into subbands of single-level 2D DWT. This step is repeated for each RGB channel. SVD is performed on LL₂ subband, generating [Ŝ Ŷ Û]Ŷ_{w} is calculated such that Ŷ_{w}=(Ŷ−Yₕ)/α. Using [S_{w} Ŷ_{w} Û_{w}], an inverse SVD is conducted to extract the watermark image in each RGB channel.

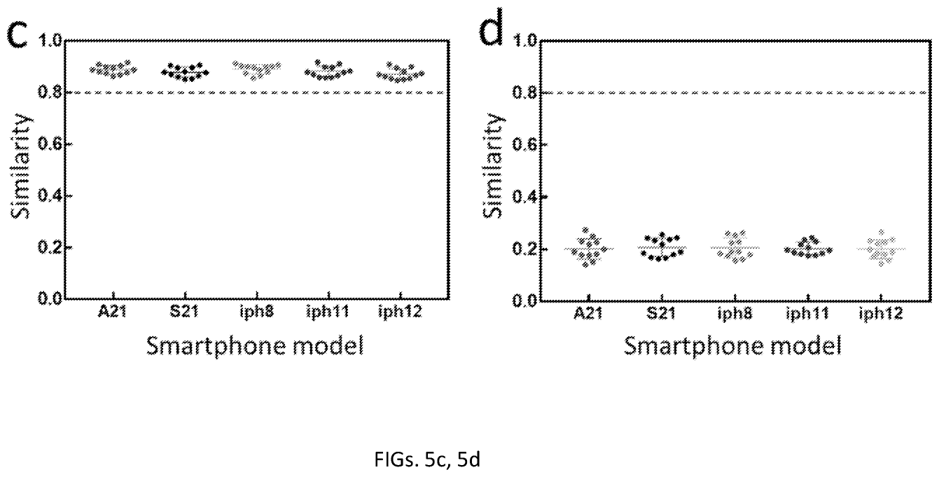

Referring to FIG. 5a photographs which show representative cases in which different watermark images embedded in the same host image result in indistinguishable watermarked images to the naked eye. In other words, the embedded watermark images are imperceptible to human vision. As shown in FIG. 5b, photographs are provided which show five smartphone models are employed to acquire the identical watermarked taggant under an illumination color temperature of 5800 K and an optical intensity of 3.1 W m⁻²; the image acquisitions are performed 12 times. After applying geometric and color corrections, the corresponding watermarks embedded in the host images are reliably extracted even when various smartphone cameras are used. The average structural similarity indices between the original and extracted watermark images are high for all the smartphone models, such as SAMSUNG GALAXY™ A21, SAMSUNG GALAXY™ S21, APPLE™ iPhone 8, APPLE™ iphone 11 Pro, and APPLE™ iPhone 12 Pro, showing the structural similarity index values of 0.89±0.02, 0.88 ±0.02, 0.89±0.02. 0.88±0.02, and 0.88±0.02 (mean±standard deviation) for the corresponding models, respectively (see FIG. 5c which is a scatter plot of structural similarity indices between the original digital (input) watermark image and the extracted watermark image from the edible watermarked taggant via the print-camera scheme for the five smartphone models. The image acquisition processes are repeated 12 times for each smartphone model). This result supports the idea that smartphone readability is seen regardless of which smartphone model is utilized.

To demonstrate the robustness of resistance to a scan-copy counterfeiting attack. an experiment was conducted assuming that a counterfeiter has full access to all of the technologies used in the present disclosure, including the FDA-approved edible dyes, the inkjet printer, and the eGFP silk fibroin print sheets. Specifically, we presume that a counterfeiter uses a high-resolution digital scanner (600 dots per inch, DPI) to obtain a digital watermarked image from the original watermarked taggant and then reprints the scanned digital watermarked image on an eGFP silk fibroin print sheet. In this simulated case, the average structural similarity indices between the original and extracted watermark images duplicated by the scan-print processes are drastically low, with structural similarity index values of 0.20±0.04. 0.21±0.03, 0.21±0.04. 0.20±0.02, and 0.20±0.03 (mean±standard deviation) for the five smartphone models (see FIG. 5d which is a scatter plot of structural similarity indices between the original digital (input) watermark image and the extracted watermark image from an edible watermarked taggant produced by a simulated copy (scan-print) attack). To recap, a counterfeit watermarked taggant is produced by scanning the original edible watermarked taggant using a scanner with a scanning resolution of 600 dots per inch (DPI) and reprinting the scanned watermarked image on the identical eGFP silk fibroin print sheet by using the same inkjet printer. The threshold value of structural similarity index can be set as 0.8 (gray dotted line) for verification or authentication. The error bars represent a standard deviation. Specifically, the fluorescent print sheet plays an important role in enhancing resistance to a copy (scan-print) attack. The eGFP silk fibroin print sheet absorbs blue light in the wavelength range of 400-500 nm while emitting green light at 500-600 nm. This unique spectral property induces significant color artifacts and distortions when exposed to white light illumination from a scanner or a copier in an attempt to duplicate a watermarked taggant. As a result, the eGFP silk fibroin print sheet makes it difficult to reliably extract the original watermark image after the simulated copy attack.

Silkworm transgenesis for eGFP silk fibroin is provided herein. We obtained eGFP silk from transgenic silkworms expressing eGFP by constructing a transformation vector pBac-3×P3-DsRed2-pFibH-eGFP. First, to form the fibroin promoter, a DNA fragment containing the promoter domain (1,124 base pairs (bp)) and the N-terminal region (1,430 bp) with intron (972 bp) of the fibroin heavy (H) gene [GenBank Accession, nucleotides (nt) 61,312 to 63,870 of No. AF226688] was amplified by polymerase chain reaction (PCR) using the genomic DNA from Bombyx mori and primers (pFibHN-F: 5′-GGCGCGCCGTGCGTGATCAGGAAAAAT-3′ and pFibHN-R: 5′-TGCACCGACTGCAGCACTA GTGCTGAA-3′). This DNA fragment was cloned into the pGEM-T Easy Vector System (Promega Co., Madison, WI, USA). The resulting plasmid was designated as pGEMT-pFibH-NTR. The DsRed2 cDNA used as a marker was amplified by PCR using specific primers with Nhel/AfII sites from pDsRed2-C1 (Nhel-DsRed2-F: 5′-GCTAGCATGGCCTCCTCCGAGAAC-3′ and DsRed2-AflII-R: 5′-CTTAAGCTACAGGAACAGGTGGTGGCG-3′; Clontech, Mountain View, CA, USA). The resultant DNA was cloned into the pGEM-T Easy Vector System, which was named as pGEMT-DsRed2. The DsRed2 gene was excised from pGEMT-DsRed2 digested with restriction enzymes of Nhel/AflII and replaced with the cGFP gene from pBac-3×P3-eGFP to form pBac-3×P3-DsRed2. The DNA fragment included the 180 bp of 3′ terminal sequence of the H-chain gene open reading frame and the 300 bp of 3′ region of the fibroin H gene (GenBank Accession, nt 79,021 to 80,009 of No. AF226688). This DNA fragment was amplified by PCR using genomic DNA isolated from Bombyx mori silkworm and primers (pFibHC-F: 5′-AGCGTCAGTTACG GAGCTGGCAGGGGA-3′ and pFibHC-R: 5′-TATAGTATTCTTAGTTGAGAAGGCATA-3′). The produced DNA fragment was cloned into pGEM-T Easy Vector System, resulting in pGEMT-CTR. The fragments were prepared by restriction enzyme treatment for pGEMT-pFibH-NTR with Ascl/BamHI and for pGEMT-CTR with Sall/Fsel, respectively. These fragments were cloned together in a pBluescriptIl SK (-) vector (Stratagene, CA, USA) treated with restriction enzymes with Apal/NotI, named as pFibHNC-null. The N- and C-terminals had the NotI and Sbfl restriction sites, respectively. The eGFP gene fragment without a termination codon was amplified from peGFP-1 using primers (eGFP-F: 5′-CGGCCGCATGGTGAGCAAGGGCGAGGAG-3′ and eGFP-R: 5′-GCTGAGGCTTTGTACAGC TCGTCCAT-3′), cloned into pGEM-T Easy Vector. This fragment was treated with NotI/Bbvcl, and then cloned into pFibHNC-null vector digested with NotI/Bbvcl, producing pFibHNC-eGFP. Finally, pFibHNC-eGFP was restriction enzyme-treated with Ascl/Fsel and was subcloned into pBac-3×P3-DsRed2 digested with Ascl/Fsel, obtaining the transformation vector pBac-3×P3-DsRed2-pFibH-eGFP.

Those having ordinary skill in the art will recognize that numerous modifications can be made to the specific implementations described above. The implementations should not be limited to the particular limitations described. Other implementations may be possible.

1. A method of ascertaining identity, verification, or authentication of a product, comprising:
embedding a predetermined watermark on a host image, thereby generating an edible watermarked image;
printing the watermarked image using edible ink on an attack-resistant edible substrate;
affixing the printed substrate onto the product;
providing a color reference chart along with the watermarked image;
obtaining an image of the watermarked image from the product;
establishing correspondence between the watermarked image and the color reference chart;
correcting the obtained image based on the established correspondence;
extracting the embedded predetermined watermark from the corrected watermarked image; and
determining identity, verification, and authentication of the product by analyzing the extracted predetermined watermark of the watermarked image.

2. The method of claim 1, wherein the product is one or more of a pharmaceutical product, a nutritional supplement product, and a food product.

3. The method of claim 2, wherein the watermarked image is printed using an edible ink.

4. The method of claim 3, wherein the edible ink is a Food and Drug Administration approved food coloring dye.

5. The method of claim 1, wherein the watermarked image is printed with an attack-resistant edible substrate material.

6. The method of claim 5, wherein the attack-resistant edible substrate material includes fluorescent materials.

7. The method of claim 6, wherein the fluorescent material for the substrate includes material selected from the group consisting of naturally occurring fluorescent proteins, animal-based proteins, plant-based proteins and pigments, lipids, genetically hybridized fluorescent proteins, edible polymers, and fluorescent food coloring dyes.

8. The method of claim 1, wherein the watermarked image is printed by an inkjet printer or laser printer.

9-11. (canceled)

12. The method of claim 1, wherein the step of extracting the embedded predetermined watermark from the corrected watermarked image is carried out at a first location associated with a priori knowledge of the predetermined watermark.

13. The method of claim 12, further comprising communicating identity, verification, and authentication of the product from the first location to a second location.

14. The method of claim 13, wherein the first location is related to where the watermarked image was first printed and the second location is related to wherein the watermarked image was obtained.

15. The method of claim 12, wherein the first location is related to where the watermarked image was obtained and the second location is related to where the watermarked image was printed.

16. The method of claim 14, wherein the communicated identity, verification, an authentication include information relevant to the product.

17. The method of claim 16, wherein the product is one of a pharmaceutical or a food product.

18. The method of claim 17, wherein the information relevant to the pharmaceutical includes one or more of name of the pharmaceutical, dosage, date of manufacture, date of expiration, location of manufacture, warning of interactions with other drugs, or base ingredients.

19. The method of claim 17, wherein the information relevant to the pharmaceutical along with information related to where the watermarked image was obtained are communicated to a third location.

20-25. (canceled)

26. The method of claim 1, wherein determining identity of the product includes one or more of i) validation associated with ensuring that the identity represents actual product issued by an actual manufacturer, ii) verification associated with ensuring the identity is corresponding to a particular product; or iii) authentication associated with ensuring the determined product is the product for which the predetermined watermark was embedded in the printed watermarked image.

27. The method of claim 7, wherein the genetically hybridized fluorescent silk proteins include silk fibroin with one or more of enhanced green fluorescent protein (eGFP), far-red fluorescent protein (mKate2), enhanced cyan fluorescent protein (eCFP), and enhanced yellow fluorescent protein (eYFP).

28-31. (canceled)

32. The method of claim 7, wherein the fluorescent food dyes and plant pigments include one or more of Citrus Red (FD&C Red #2), Erythrosine B (FD&C Red #3), Allura Red (FD&C Red #40), Brilliant Blue (FD&C blue #1), Indigo carmine (FD&C blue #2), Fast Green (FD&C Green #3), Orange B, Tartrazine (FD&C Yellow #6), Sunset Yellow (FD&C Yellow #6), Tartrazine (FD&C Yellow #5), Betaxanthins, Chlorophyll, Carotenoids, Anthocyanin, Betalains, Fisetin, Quercetin, Quinine, Curcumin, Anthocyanin, Riboflavin, Vanillin, and Benzaldehyde.

33-36. (canceled)

37. The method of claim 4, wherein the edible ink includes water, glycerin (polyalcohol), ethanol (monoalcohol), FDA-approved color dyes, and a preservative (polysorbate 80, propylene glycol).

38-39. (canceled)
